(19) United States
(12) Patent Application Publication
(10) Pub. No.: US 2015/0147583 A1
(43) Pub. Date: May 28, 2015

(54) Films and Methods of Making the Same

(71) Applicant: ExxonMobil Chemical Company, Baytown, TX (US)

(72) Inventors: Fang Bao, Shanghai (CN); Becky Jin Na Zhao, Shanghai (CN); Achiel J. Van Loon, Schoten (BE)

(21) Appl. No.: 14/517,366

(22) Filed: Oct. 17, 2014

(30) Foreign Application Priority Data
Nov. 27, 2013 (CN) PCT/CN2013/001455

(51) Int. Cl. C08J 5/18; B32B 27/32; B31B 1/64; B32B 27/08

(52) U.S. Cl. CPC C08J 5/18; B32B 27/08; B32B 27/32; B31B 1/64; C08J 2323/06; C08J 2423/06; C08J 2423/12; B32B 2250/02; B32B 2250/242; B32B 2270/00; B32B 2323/04; B32B 2323/10; B32B 2439/00
USPC 428/516; 525/240; 524/528; 521/134; 493/133

(57) ABSTRACT

Disclosed are films which can provide seal strengths suited for both peelable and nonpeelable seals in a package.

### CROSS-REFERENCE TO RELATED APPLICATIONS

This application claims the benefit of International Patent Application No. PCT/CN2013/001455, filed Nov. 27, 2013, the disclosure of which is fully incorporated by reference.

### FIELD OF THE INVENTION

This invention relates to films, and in particular, the present invention relates to films for forming peelable and nonpeelable seals, methods for making such films, and packages made therefrom.

### BACKGROUND OF THE INVENTION

Packaging is an important feature in preserving and commercializing most products. Food products and medical devices, in particular, have strict packaging requirements to reduce exposure to atmospheric conditions such as moisture or oxygen. In such applications, packages are generally impervious to air and contaminants, and are typically vacuum-packed or gas-flushed, and subsequently hermetically sealed. During use, ease of tearing apart a seal is often desired when a consumer tries to open a package by the seal. One commonly used package structure to provide the easy-open characteristic includes a peelable seal.

Peelability generally refers to the ability to separate two materials in the course of opening a package without compromising their integrity. The force required to pull a seal apart is called “seal strength” or “heat seal strength” which can be measured in accordance with or based on ASTM F88. The desired seal strength varies according to specific end user applications. For flexible packaging applications, such as cereal liners, snack food packages, cracker tubes and cake mix liners, the seal strength desired is generally in the range of 1-9 lbs per inch (about 2.63-23.67 N/15 mm). For example, for easy-open cereal box liners, a seal strength in the range of 1-3 lbs per inch (about 2.63-7.89 N/15 mm) is commonly specified, although specific targets vary according to individual manufactures requirements. In addition to flexible packaging application, a peelable seal can also be used in rigid package applications, such as lids for convenience items (for example, snack food such as puddings) and medical devices. Typical rigid packages have a seal strength of 1-5 lbs per inch (about 2.63-13.15 N/15 mm). The seal layer can be on the lid, on the container, or both.

Films made from one or more polymers are widely employed for peelable seals. The resulting characteristics of a peelable seal depend largely upon the specific types of resins used in the film to form the seal. Currently, polymer compositions, such as those made of ethylene vinyl acetate (EVA) and polybutylene, those made of EVA and ionomers and those made of polyethylene and polypropylene, are commonly used to produce films used for peelable seals. While the above solutions work reasonably well for peelable seals, the obtained seal strength is relatively low, usually below 3 lbs per inch (about 7.89 N/15 mm), regardless of the sealing temperature chosen during processing. However, in a single end use package, different seal strengths are preferred for different seals, i.e., low seal strength is intended for the peelable seal to be easily opened while relatively high seal strength may be desired for other seals that are expected to be nonpeelable to ensure package integrity. Therefore, with conventional resin systems, it has been difficult for package manufactures to achieve different seal strengths where necessary with only one film throughout the entire package.

U.S. Pat. No. 7,863,383 discloses a polyolefin-based heat sealable and peelable seal. The peelable seals comprise from 5 to 98 percent by weight of a propylene based plastomer or elastomer and from 2 to 95 percent by weight of a second polymer selected from the group consisting of polyethylene, polybutylene, and styrenic polymer and mixtures thereof. The invention also relates to tamper evident peelable seals. The invention also relates to methods of making and using the heat sealable, peelable seal.

U.S. Pat. Nos. 7,871,696, 7,871,697, 8,110,286, and 8,470,397 provide a peelable sealing structure including a sealing layer and one or more optional additional layers. The peelable sealing structure includes a sealing surface that is formable into a peelable seal upon contact with a sealing substrate at all temperatures in a peelable seal temperature range. Moreover, the peelable sealing structure comprises a thermoplastic polymer and an additive dispersed within at least a portion of the thermoplastic polymer with the peelable sealing structure defining the sealing surface.

U.S. Pat. No. 8,053,048 relates to a polymer blend comprising a high density polyethylene and a surface enhancing polymer. The surface enhancing polymer may be an elastomer such as an ethylene propylene diene monomer terpolymer. The polymer blend may be fabricated into articles such as a film or a flexible overpouch for storing, and transporting medical components. Overpouch films made from the blend advantageously do not wrinkle or deform medical components contained therein when the overpouch-medical component combination is autoclaved.

U.S. Pat. No. 8,003,179 provides film structures, packages, films and methods of making the same wherein the film structures have a desiccant material incorporated into at least one layer of the film structures and further wherein the film structures can comprise a material for making a peelable seal when the film structures are heat sealed to other film structures. The film structures are utilized for a package to hold a product that may be sensitive to the presence of moisture.

U.S. Pat. No. 6,590,034 relates to a peelable seal comprising a mixture of at least two immiscible polymers. The first polymer forms a continuous phase in the peelable seal, whereas the second polymer is dispersed in the continuous phase. For example, a peelable seal can also be made from a mixture of an ethylene polymer with a melt index in the range from about 0.1 to about 20 g/10 minutes and a propylene polymer with a melt flow rate in the range from about 0.01 to about 2 g/10 minutes. Preferably, the shear viscosity differential is less than about 100%.

As discussed above, there exists a need for a film capable of providing both peelable and nonpeelable seals with respective desired seal strengths within one package, so as to increase ease and cost-effectiveness in the package manufacturing process and improve package sealing performance for end use. Applicants have found that the above objective can be achieved by applying a composition of a propylene-based elastomer, a first polyethylene having a density of at least about 0.930 g/cm3 and a second polyethylene having a density lower than 0.930 g/cm3, particularly at certain ratios, to prepare a film, which can demonstrate dual seal strengths at two different sealing temperature ranges. The film made of such composition has a seal strength well suited for use as a peelable seal when processed at a relatively low sealing temperature and has a seal strength desirable for use as a nonpeelable seal when processed at a relatively high sealing temperature. Therefore, simply by adjusting the sealing temperature of different heat sealing bars during the heat sealing process, a package with the inventive film can be produced to simultaneously provide both peelable and nonpeelable seals.

### SUMMARY OF THE INVENTION

Provided are films, peelable and nonpeelable seals comprising such films, packages comprising such seals and methods for making such films and packages.

In accordance with one embodiment of the present invention, the invention encompasses a film comprising a layer comprising a propylene-based elastomer, a first polyethylene having a density of at least about 0.930 g/cm3, and a second polyethylene having a density lower than 0.930 g/cm3. Preferably, the film has at least one of the following properties: (i) a seal strength of about 1 N/15 mm to about 3 N/15 mm (EMC method as described herein) at a sealing temperature of 75° C. to 100° C., (ii) a seal strength of about 0.8 N/15 mm to about 4 N/15 mm at a sealing temperature of 100° C. to 110° C., (iii) a seal strength of about 8 N/15 mm to about 15 N/15 mm at a sealing temperature of 105° C. to 150° C., and (iv) a seal strength of about 15 N/15 mm to about 22 N/15 mm at a sealing temperature of 120° C. to 160° C. More preferably, the film has a seal strength of about 1 N/15 mm to about 3 N/15 mm at a sealing temperature of 75° C. to 100° C. and a seal strength of about 8 N/15 mm to about 15 N/15 mm at a sealing temperature of 105° C. to 150° C. More preferably, the film has a seal strength of about 0.8 N/15 mm to about 4 N/15 mm at a sealing temperature of 100° C. to 110° C. and a seal strength of about 15 N/15 mm to about 22 N/15 mm at a sealing temperature of 120° C. to 160° C.

Also provided are peelable seals and nonpeelable seals comprising any of the films described herein or made according to any method disclosed herein. Packages comprising the seals described herein are also provided.

In another embodiment, the present invention relates to a method for making a film comprising the steps of: (a) preparing a layer comprising a propylene-based elastomer, a first polyethylene having a density of at least about 0.930 g/cm3, and a second polyethylene having a density lower than 0.930 g/cm3; and (b) forming a film comprising the layer in step (a).

Also provided are methods for making a package, comprising the steps of: (a) preparing a layer comprising a propylene-based elastomer, a first polyethylene having a density of at least about 0.930 g/cm3, and a second polyethylene having a density lower than 0.930 g/cm3; (b) forming a film comprising the layer in step (a); and (c) forming a package comprising the film in step (b). Preferably, step (c) comprises: preparing a peelable seal comprising the film in step (b); preparing a nonpeelable seal comprising the film in step (b); and combining the peelable seal with the nonpeelable seal to form a package. Preferably, the peelable seal is prepared at a sealing temperature of 75° C. to 110° C. Preferably, the nonpeelable seal is prepared at a sealing temperature of 105° C. to 160° C.

### BRIEF DESCRIPTION OF THE DRAWINGS

FIG. 1 depicts typical seal strengths over a range of sealing temperatures for a conventional peelable seal comprising a composition of polyethylene and an ionomer or EVA.

FIG. 2 depicts seal strengths over a range of sealing temperatures for each of the samples in Example 1.

FIG. 3 depicts hot tack forces over a range of sealing temperatures for each of the samples in Example 1.

FIG. 4 depicts seal strengths over a range of sealing temperatures for each of the samples in Example 2.

### DETAILED DESCRIPTION OF THE PRESENT INVENTION

Various specific embodiments, versions of the present invention will now be described, including preferred embodiments and definitions that are adopted herein. While the following detailed description gives specific preferred embodiments, those skilled in the art will appreciate that these embodiments are exemplary only, and that the present invention can be practiced in other ways. Any reference to the “invention” may refer to one or more, but not necessarily all, of the present inventions defined by the claims. The use of headings is for purposes of convenience only and does not limit the scope of the present invention.

As used herein, a “polymer” may be used to refer to homopolymers, copolymers, interpolymers, terpolymers, etc. A “polymer” has two or more of the same or different monomer units. A “homopolymer” is a polymer having monomer units that are the same. A “copolymer” is a polymer having two or more monomer units that are different from each other. A “terpolymer” is a polymer having three monomer units that are different from each other. The term “different” as used to refer to monomer units indicates that the monomer units differ from each other by at least one atom or are different isomerically. Accordingly, the definition of copolymer, as used herein, includes terpolymers and the like. Likewise, the definition of polymer, as used herein, includes copolymers and the like. Thus, as used herein, the terms “polyethylene,” “ethylene polymer,” “ethylene copolymer,” and “ethylene based polymer” mean a polymer or copolymer comprising at least 50 mol % ethylene units (preferably at least 70 mol % ethylene units, more preferably at least 80 mol % ethylene units, even more preferably at least 90 mol % ethylene units, even more preferably at least 95 mol % ethylene units or 100 mol % ethylene units (in the case of a homopolymer)). Furthermore, the term “polyethylene composition” means a composition containing one or more polyethylene components.

As used herein, when a polymer is referred to as comprising a monomer, the monomer is present in the polymer in the polymerized form of the monomer or in the derivative form of the monomer.

As used herein, when a polymer is said to comprise a certain percentage, wt %, of a monomer, that percentage of monomer is based on the total amount of monomer units in the polymer.

As used herein, “elastomer” or “elastomeric composition” refers to any polymer or composition of polymers (such as blends of polymers) consistent with the ASTM D1566 definition. Elastomer includes mixed blends of polymers such as melt mixing and/or reactor blends of polymers.

For purposes of this invention and the claims thereto, an ethylene polymer having a density of 0.86 g/cm³ or less is referred to as an ethylene elastomer; an ethylene polymer having a density of more than 0.86 to less than 0.910 g/cm³ is referred to as an ethylene plastomer; an ethylene polymer having a density of 0.910 to 0.940 g/cm³ is referred to as a low density polyethylene (LDPE); and an ethylene polymer having a density of more than 0.940 g/cm³ is referred to as a high density polyethylene (HDPE).

Polyethylene having a density of 0.890 to 0.930 g/cm³, typically from 0.915 to 0.930 g/cm³, that is linear and does not contain long chain branching is referred to as “linear low density polyethylene” (LLDPE) and can be produced with conventional Ziegler-Natta catalysts, vanadium catalysts, or with metallocene catalysts in gas phase reactors and/or in slurry reactors and/or with any of the disclosed catalysts in solution reactors. “Linear” means that the polyethylene has no or only a few long chain branches, typically referred to as a g′vis of 0.97 or above, preferably 0.98 or above.

As used herein, “seal strength” or “heat seal strength” refers to the force to separate two layers in accordance with ASTM F-88 which is incorporated by references. For example, this is the force necessary to separate two layers of a defined width, such as one inch or 15 mm, by pulling. As used herein, the seal strength is measured herein based on ASTM F88 using a Zwick Tensile Tester pulled at 90° angle from the seal at a speed of 500 mm/min after samples with a width of 15 mm are conditioned in the constant temperature lab for at least 40 hours at a temperature of 23° C.±2° C. and at a relative humidity of 50%±10%, which method is specifically developed by Applicant based on ASTM F88 and is herein referred to as “EMC method”.

As used herein, “peelable seal” means a seal that has a seal strength of between 0.5 lbs per inch (about 1.32 N/15 mm) of sample width and a force that tears the seal. Typically, the upper limit is less than or equal to 5 lbs per inch (about 13.15 N/15 mm) of sample width. Preferably, the upper limit is less than or equal to 4 lbs per inch (about 10.52 N/15 mm) of sample width or less than the tear strength on the film substrate. A “nonpeelable seal” generally refers to a seal having a seal strength greater than about 5 lbs per inch (about 13.15 N/15 mm) of sample width.

As used herein, “seal initiation temperature” refers to the lowest temperature at which a seal is formed with a seal strength of 0.5 lbs per inch (about 1.32 N/15 mm). Specifically, the seal initiation temperature is the temperature of a sealing bar contacting a layer or layers that are to be sealed thereby promoting such sealing. In some variations, the surface contacts the layer(s) with a dwell time from about 0.5 to 1 second with a pressure from 5 psi to 1200 psi (about 0.034 MPa to about 8.276 MPa).

As used herein, “peelable seal temperature range” means the range of temperatures at which a seal between two materials is formed such that the seal strength is between 0.5 lbs per inch (about 1.32 N/15 mm) of sample width and a force that tears the seal as set forth above.

As used herein, “hot tack” refers to the seal strength of a seal while it is still in a molten state, which is measured herein based on ASTM F1921-12 using a J&B Hot Tack Tester Model 4000 with a 0.5 sec dwell time, with a 0.5 MPa bar pressure pulled at a speed of 200 mm/sec after 0.4 sec of welding seal.

As used herein, “Composition Distribution Breadth Index” (CDBI) is a measure of the composition distribution of monomer within the polymer chains and is measured by the procedure described in PCT Publication No. WO 93/03093, published Feb. 18, 1993, specifically columns 7 and 8 as well as in Wild et al, J. Poly. Sci., Poly. Phys. Ed., Vol. 20, p. 441 (1982) and U.S. Pat. No. 5,008,204, including that fraction having a weight average molecular weight (Mw) below 15,000 are ignored when determining CDBI.

The present invention relates to a film comprising a layer comprising a propylene-based elastomer, a first polyethylene having a density of at least about 0.930 g/cm3, and a second polyethylene having a density lower than 0.930 g/cm3. Preferably, the propylene-based elastomer is present in an amount of about 5 to about 50 wt %, based on total weight of the polymer in the layer. Preferably, the weight ratio between the first polyethylene and the second polyethylene is about 1:2 to about 1:5. Preferably, the film has at least one of the following properties: (i) a seal strength of about 1 N/15 mm to about 3 N/15 mm at a sealing temperature of 75° C. to 100° C., (ii) a seal strength of about 0.8 N/15 mm to about 4 N/15 mm at a sealing temperature of 100° C. to 110° C., (iii) a seal strength of about 8 N/15 mm to about 15 N/15 mm at a sealing temperature of 105° C. to 150° C., and (iv) a seal strength of about 15 N/15 mm to about 22 N/15 mm at a sealing temperature of 120° C. to 160° C. More preferably, the film has a seal strength of about 1 N/15 mm to about 3 N/15 mm at a sealing temperature of 75° C. to 100° C. and a seal strength of about 8 N/15 mm to about 15 N/15 mm at a sealing temperature of 105° C. to 150° C. More preferably, the film has a seal strength of about 0.8 N/15 mm to about 4 N/15 mm at a sealing temperature of 100° C. to 110° C. and a seal strength of about 15 N/15 mm to about 22 N/15 mm at a sealing temperature of 120° C. to 160° C.

Also provided are peelable seals and nonpeelable seals comprising any of the films described herein. Packages comprising the seals described herein are also provided. Preferably, the package has a seal strength of about 0.8 N/15 mm to about 4 N/15 mm at the peelable seal. Preferably, the package has a seal strength of about 8 N/15 mm to about 22 N/15 mm at the nonpeelable seal.

### Propylene-Based Elastomers

The film of the present invention comprises a propylene-based elastomer. Preferably, the propylene-based elastomer has at least about 60 wt % propylene-derived units and about 3 to about 25 wt % ethylene-derived units, based on total weight of the propylene-based elastomer, and a heat of fusion of less than about 80 J/g. Preferably, the propylene-based elastomer is present in an amount of about 5 to about 50 wt %, for example, in an amount of anywhere from a lower limit of 5, 10, 15, 20, or 25 wt %, to an upper limit of 30, 35, 40, 45, or 50 wt %, based on total weight of the polymer in the layer comprising the propylene-based elastomer.

The propylene-based elastomer is a copolymer of propylene-derived units and units derived from at least one of ethylene or a C4-C10 alpha-olefin. The propylene-based elastomer may contain at least about 50 wt % propylene-derived units. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

The amount of propylene-derived units present in the propylene-based elastomer may range from an upper limit of about 95 wt %, about 94 wt %, about 92 wt %, about 90 wt %, or about 85 wt %, to a lower limit of about 60 wt %, about 65 wt %, about 70 wt %, about 75 wt %, about 80 wt %, about 84 wt %, or about 85 wt % of the propylene-based elastomer.

The units or comonomers derived from at least one of ethylene or a C4-C10 alpha-olefin may be present in an amount of about 1 to about 35 wt %, or about 5 to about 35 wt %, or about 7 to about 30 wt %, or about 8 to about 25 wt %, or about 8 to about 20 wt %, or about 8 to about 18 wt %, of the propylene-based elastomer. The comonomer content may be adjusted so that the propylene-based elastomer has a heat of fusion of less than about 80 J/g, a melting point of about 105° C. or less, and a crystallinity of about 2% to about 65% of the crystallinity of isotactic polypropylene, and a fractional melt flow rate of about 0.5 to about 20 g/min.

In preferred embodiments, the comonomer is ethylene, 1-hexene, or 1-octene, with ethylene being most preferred. In embodiments where the propylene-based elastomer comprises ethylene-derived units, the propylene-based elastomer may comprise about 3 to about 25 wt %, or about 5 to about 20 wt %, or about 9 to about 16 wt % of ethylene-derived units. In some embodiments, the propylene-based elastomer consists essentially of units derived from propylene and ethylene, i.e., the propylene-based elastomer does not contain any other comonomer in an amount other than that typically present as impurities in the ethylene and/or propylene feedstreams used during polymerization, or in an amount that would materially affect the heat of fusion, melting point, crystallinity, or fractional melt flow rate of the propylene-based elastomer, or in an amount such that any other comonomer is intentionally added to the polymerization process.

In some embodiments, the propylene-based elastomer may comprise more than one comonomer. Preferred embodiments of a propylene-based elastomer having more than one comonomer include propylene-ethylene-octene, propylene-ethylene-hexene, and propylene-ethylene-butene polymers. In embodiments where more than one comonomer derived from at least one of ethylene or a C4-C10 alpha-olefin is present, the amount of one comonomer may be less than about 5 wt % of the propylene-based elastomer, but the combined amount of comonomers of the propylene-based elastomer is about 5 wt % or greater.

The propylene-based elastomer may have a triad tacticity of three propylene units, as measured by 13C NMR, of at least about 75%, at least about 80%, at least about 82%, at least about 85%, or at least about 90%. Preferably, the propylene-based elastomer has a triad tacticity of about 50 to about 99%, or about 60 to about 99%, or about 75 to about 99%, or about 80 to about 99%. In some embodiments, the propylene-based elastomer may have a triad tacticity of about 60 to 97%.

The propylene-based elastomer has a heat of fusion (“Hf”), as determined by DSC, of about 80 J/g or less, or about 70 J/g or less, or about 50 J/g or less, or about 40 J/g or less. The propylene-based elastomer may have a lower limit Hf of about 0.5 J/g, or about 1 J/g, or about 5 J/g. For example, the Hf value may range from a lower limit of about 1.0, 1.5, 3.0, 4.0, 6.0, or 7.0 J/g, to an upper limit of about 35, 40, 50, 60, 70, 75, or 80 J/g.

The propylene-based elastomer may have a percent crystallinity, as determined according to the DSC procedure described herein, of about 2 to about 65%, or about 0.5 to about 40%, or about 1 to about 30%, or about 5 to about 35%, of the crystallinity of isotactic polypropylene. The thermal energy for the highest order of propylene (i.e., 100% crystallinity) is estimated at 189 J/g. In some embodiments, the copolymer has crystallinity less than 40%, or in the range of about 0.25 to about 25%, or in the range of about 0.5 to about 22% of the crystallinity of isotactic polypropylene.

Embodiments of the propylene-based elastomer may have a tacticity index m/r from a lower limit of about 4, or about 6, to an upper limit of about 8, or about 10, or about 12. In some embodiments, the propylene-based elastomer has an isotacticity index greater than 0%, or within the range having an upper limit of about 50%, or about 25%, and a lower limit of about 3%, or about 10%.

In some embodiments, the propylene-based elastomer may further comprise diene-derived units (as used herein, “diene”). The optional diene may be any hydrocarbon structure having at least two unsaturated bonds wherein at least one of the unsaturated bonds is readily incorporated into a polymer. For example, the optional diene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkyliene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of diene-derived units present in the propylene-based elastomer may range from an upper limit of about 15%, about 10%, about 7%, about 5%, about 4.5%, about 3%, about 2.5%, or about 1.5%, to a lower limit of about 0%, about 0.1%, about 0.2%, about 0.3%, about 0.5%, about 1%, about 3%, or about 5%, based on the total weight of the propylene-based elastomer.

The propylene-based elastomer may have a single peak melting transition as determined by DSC. In some embodiments, the copolymer has a primary peak transition of about 90° C. or less, with a broad end-of-melt transition of about 110° C. or greater. The peak “melting point” (“Tm”) is defined as the temperature of the greatest heat absorption within the range of melting of the sample. However, the copolymer may show secondary melting peaks adjacent to the principal peak, and/or at the end-of-melt transition. For the purposes of this disclosure, such secondary melting peaks are considered together as a single melting point, with the highest of these peaks being considered the Tm of the propylene-based elastomer. The propylene-based elastomer may have a Tm of about 110° C. or less, about 105° C. or less, about 100° C. or less, about 90° C. or less, about 80° C. or less, or about 70° C. or less. In some embodiments, the propylene-based elastomer has a Tm of about 25 to about 105° C., or about 40 to about 100° C., or about 50 to about 90° C., or about 60 to about 80° C.

The propylene-based elastomer may have a density of about 0.850 to about 0.900 g/cm3, or about 0.860 to about 0.880 g/cm3, at room temperature as measured based on ASTM D1505.

The propylene-based elastomer may have a fractional melt flow rate, as measured based on ASTM D1238, 2.16 kg at 230° C., of at least about 0.5 g/10 min. In some embodiments, the propylene-based elastomer may have a fractional melt flow rate of about 0.5 to about 20 g/10 min, or about 2 to about 10 g/10 min, or about 2 to about 5 g/10 min.

The propylene-based elastomer may have an Elongation at Break of less than about 2000%, less than about 1800%, less than about 1500%, or less than about 1000%, as measured based on ASTM D638.

The propylene-based elastomer may have a weight average molecular weight (Mw) of about 5,000 to about 5,000,000 g/mole, or about 10,000 to about 1,000,000 g/mole, or about 50,000 to about 400,000 g/mole. The propylene-based elastomer may have a number average molecular weight (Mn) of about 2,500 to about 250,000 g/mole, or about 10,000 to about 250,000 g/mole, or about 25,000 to about 250,000 g/mole. The propylene-based elastomer may have a z-average molecular weight (Mz) of about 10,000 to about 7,000,000 g/mole, or about 80,000 to about 700,000 g/mole, or about 100,000 to about 500,000 g/mole.

The propylene-based elastomer may have a molecular weight distribution (“MWD”) of about 1.5 to about 20, or about 1.5 to about 15, or about 1.5 to about 5, or about 1.8 to about 3, or about 1.8 to about 2.5.

In some embodiments, the propylene-based elastomer is an elastomer including propylene-crystallinity, a melting point by DSC equal to or less than 105° C., and a heat of fusion of from about 5 J/g to about 45 J/g. The propylene-derived units are present in an amount of about 80 to about 90 wt %, based on the total weight of the propylene-based elastomer. The ethylene-derived units are present in an amount of about 8 to about 18 wt %, for example, about 8, about 8.5, about 9, about 9.5, about 10, about 10.5, about 11, about 11.5, about 12, about 12.5, about 13, about 13.5, about 14, about 14.5, about 15, about 15.5, about 16, about 16.5, about 17, about 17.5, about 18 wt %, based on the total weight of the propylene-based elastomer.

The compositions disclosed herein may include one or more different propylene-based elastomers, i.e., propylene-based elastomers each having one or more different properties such as, for example, different comonomer or comonomer content. Such combinations of various propylene-based elastomers are all within the scope of the invention.

Suitable propylene-based elastomers may be available commercially under the trade names VISTAMAXX™ (ExxonMobil Chemical Company, Houston, Tex., USA), VERSIFY™ (The Dow Chemical Company, Midland, Mich., USA), certain grades of TAFMER™ XM or NOTIO™ (Mitsui Company, Japan), and certain grades of SOFTEL™ (Basell Polyolefins of the Netherlands). The particular grade(s) of commercially available propylene-based elastomer suitable for use in the invention can be readily determined using methods commonly known in the art.

### Ethylene Polymers

The propylene-based elastomer described herein is combined with at least two ethylene polymers, a first one having a density of at least about 0.930 g/cm3 and a second one having a density lower than 0.930 g/cm3, to prepare the film of the present invention.

In one aspect of the invention, the ethylene polymers are selected from ethylene homopolymers, ethylene copolymers, and compositions thereof. Useful copolymers comprise one or more comonomers in addition to ethylene and can be a random copolymer, a statistical copolymer, a block copolymer, and/or compositions thereof. In particular, the ethylene polymer compositions described herein may be physical blends or in situ blends of more than one type of ethylene polymer or compositions of ethylene polymers with polymers other than ethylene polymers where the ethylene polymer component is the majority component (e.g., greater than 50 wt %). The method of making the polyethylene is not critical, as it can be made by slurry, solution, gas phase, high pressure or other suitable processes, and by using catalyst systems appropriate for the polymerization of polyethylenes, such as Ziegler-Natta-type catalysts, chromium catalysts, metallocene-type catalysts, other appropriate catalyst systems or combinations thereof, or by free-radical polymerization. In a preferred embodiment, the ethylene polymers are made by the catalysts, activators and processes described in U.S. Pat. Nos. 6,342,566; 6,384,142; 5,741,563; PCT Publication Nos. WO 03/040201 and WO 97/19991. Such catalysts are well known in the art, and are described in, for example, ZIEGLER CATALYSTS (Gerhard Fink, Rolf Mülhaupt and Hans H. Brintzinger, eds., Springer-Verlag 1995); Resconi et al.; and I, II METALLOCENE-BASED POLYOLEFINS (Wiley & Sons 2000).

Preferred ethylene polymers and copolymers that are useful in this invention include those sold by ExxonMobil Chemical Company in Houston Tex., including HDPE, LLDPE, and LDPE; and those sold under the ENABLE™, EXACT™, EXCEED™ ESCORENE™, EXXCO™, ESCOR™, PAXON™, and OPTEMA™ tradenames.

Preferred ethylene homopolymers and copolymers useful in this invention typically have:

1. an Mw of 20,000 g/mol or more, 20,000 to 2,000,000 g/mol preferably 30,000 to 1,000,000, preferably 40,000 to 200,000, preferably 50,000 to 750,000, as measured by size exclusion chromatography; and/or

2. an Mw/Mn of 1 to 40, preferably 1.6 to 20, or 8 to 25, more preferably 1.8 to 10, more preferably 1.8 to 4, as measured by size exclusion chromatography; and/or

3. a Tm of 30° C. to 150° C., preferably 30° C. to 140° C., preferably 50° C. to 140° C., more preferably 60° C. to 135° C., as determined based on ASTM D3418-03; and/or

4. a crystallinity of 5% to 80%, preferably 10% to 70%, more preferably 20% to 60% preferably at least 30%, or at least 40%, or at least 50%, as determined based on ASTM D3418-03; and/or

5. a heat of fusion of 300 J/g or less, preferably 1 to 260 J/g, preferably 5 to 240 J/g, preferably 10 to 200 J/g, as determined based on ASTM D3418-03; and/or

6. a crystallization temperature (Tc) of 15° C. to 130° C., preferably 20° C. to 120° C., more preferably 25° C. to 110° C., preferably 60° C. to 125° C., as determined based on ASTM D3418-03; and/or

7. a heat deflection temperature of 30° C. to 120° C., preferably 40° C. to 100° C., more preferably 50° C. to 80° C. as measured based on ASTM D648 on injection molded flexure bars, at 66 psi load (455 kPa); and/or

8. a Shore hardness (D scale) of 10 or more, preferably 20 or more, preferably 30 or more, preferably 40 or more, preferably 100 or less, preferably from 25 to 75 (as measured based on ASTM D 2240); and/or

9. a percent amorphous content of at least 50%, preferably at least 60%, preferably at least 70%, more preferably between 50% and 95%, or 70% or less, preferably 60% or less, preferably 50% or less as determined by subtracting the percent crystallinity from 100; and/or

10. a branching index (g'vis) of 0.97 or more, preferably 0.98 or more, preferably 0.99 or more, preferably 1; and/or

11. a density of at least about 0.930 g/cm3 (preferably between 0.930 and 0.940 g/cm3) for a first polyethylene and lower than 0.930 g/cm3 (preferably between 0.910 and 0.925 g/cm3) for a second polyethylene (determined based on ASTM D 1505 using a density-gradient column on a compression-molded specimen that has been slowly cooled to room temperature (i.e. over a period of 10 minutes or more) and allowed to age for a sufficient time that the density is constant within +/−0.001 g/cm3).

The polyethylene may be an ethylene homopolymer, such as HDPE. In one embodiment the ethylene homopolymer has a molecular weight distribution (Mw/Mn) of up to 40, preferably ranging from 1.5 to 20, or from 1.8 to 10, or from 1.9 to 5, or from 2.0 to 4. In another embodiment, the 1% secant flexural modulus (determined based on ASTM D790A, where test specimen geometry is as specified under the ASTM D790 section “Molding Materials (Thermoplastics and Thermosets),” and the support span is 2 inches (5.08 cm)) of the ethylene polymer falls in a range of 200 to 1000 MPa, and from 300 to 800 MPa in another embodiment, and from 400 to 750 MPa in yet another embodiment, wherein a desirable polymer may exhibit any combination of any upper flexural modulus limit with any lower flexural modulus limit. The melt index (MI) of preferred ethylene homopolymers range from 0.05 to 800 dg/min in one embodiment, and from 0.1 to 100 dg/min in another embodiment, as measured based on ASTM D1238 (190° C., 2.16 kg).

In a preferred embodiment, the polyethylene comprises less than 20 mol % propylene units (preferably less than 15 mol %, preferably less than 10 mol %, preferably less than 5 mol %, preferably 0 mol % propylene units).

In another embodiment of the invention, the ethylene polymer useful herein is produced by polymerization of ethylene and, optionally, an alpha-olefin with a catalyst having as a transition metal component a bis(n-C3-4 alkyl cyclopentadienyl) hafnium compound, wherein the transition metal component preferably comprises from about 95 mol % to about 99 mol % of the hafnium compound as further described in U.S. Pat. No. 9,956,088.

In another embodiment of the invention, the ethylene polymer is an ethylene copolymer, either random, or block, of ethylene and one or more comonomers selected from C3 to C20 α-olefins, typically from C3 to C10 α-olefins. Preferably, the comonomers are present from 0.1 wt % to 50 wt % of the copolymer in one embodiment, and from 0.5 wt % to 30 wt % in another embodiment, and from 1 wt % to 15 wt % in yet another embodiment, and from 0.1 wt % to 5 wt % in yet another embodiment, wherein a desirable copolymer comprises ethylene and C3 to C20 α-olefin derived units in any combination of any upper wt % limit with any lower wt % limit described herein. Preferably the ethylene copolymer will have a weight average molecular weight of from greater than 8,000 g/mol in one embodiment, and greater than 10,000 g/mol in another embodiment, and greater than 12,000 g/mol in yet another embodiment, and greater than 20,000 g/mol in yet another embodiment, and less than 1,000,000 g/mol in yet another embodiment, and less than 800,000 g/mol in yet another embodiment, wherein a desirable copolymer may comprise any upper molecular weight limit with any lower molecular weight limit described herein.

In another embodiment, the ethylene copolymer comprises ethylene and one or more other monomers selected from the group consisting of C3 to C20 linear, branched or cyclic monomers, and in some embodiments is a C3 to C12 linear or branched alpha-olefin, preferably butene, pentene, hexene, heptene, octene, nonene, decene, dodecene, 4-methyl-pentene-1,3-methyl pentene-1,3,5,5-trimethyl-hexene-1, and the like. The monomers may be present at up to 50 wt %, preferably from 0 wt % to 40 wt %, more preferably from 0.5 wt % to 30 wt %, more preferably from 2 wt % to 30 wt %, more preferably from 5 wt % to 20 wt %, based on the total weight of the ethylene copolymer.

Preferred linear alpha-olefins useful as comonomers for the ethylene copolymers useful in this invention include C3 to C8 alpha-olefins, more preferably 1-butene, 1-hexene, and 1-octene, even more preferably 1-hexene. Preferred branched alpha-olefins include 4-methyl-1-pentene, 3-methyl-1-pentene, and 3,5,5-trimethyl-1-hexene, 5-ethyl-1-nonene. Preferred aromatic-group-containing monomers contain up to 30 carbon atoms. Suitable aromatic-group-containing monomers comprise at least one aromatic structure, preferably from one to three, more preferably a phenyl, indenyl, fluorenyl, or naphthyl moiety. The aromatic-group-containing monomer further comprises at least one polymerizable double bond such that after polymerization, the aromatic structure will be pendant from the polymer backbone. The aromatic-group containing monomer may further be substituted with one or more hydrocarbyl groups including but not limited to C1 to C10 alkyl groups. Additionally, two adjacent substitutions may be joined to form a ring structure. Preferred aromatic-group-containing monomers contain at least one aromatic structure appended to a polymerizable olefinic moiety. Particularly, preferred aromatic monomers include styrene, alpha-methylstyrene, para-alkylstyrenes, vinyltoluenes, vinylnaphthalene, allyl benzene, and indene, especially styrene, paramethyl styrene, 4-phenyl-1-butene and allyl benzene.

Preferred diolefin monomers useful in this invention include any hydrocarbon structure, preferably C4 to C30, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e. di-vinyl monomers). More preferably, the diolefin monomers are linear di-vinyl monomers, most preferably those containing from 4 to 30 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, vinylnorbornene, norbornadiene, ethylidene norbornene, divinylbenzene, dicyclopentadiene or higher ring containing diolefins with or without substituents at various ring positions.

In a preferred embodiment, one or more dienes are present in the ethylene polymer at up to 10 wt %, preferably at 0.00001 wt % to 2 wt %, preferably 0.002 wt % to 1 wt %, even more preferably 0.003 wt % to 0.5 wt %, based upon the total weight of the ethylene polymer. In some embodiments diene is added to the polymerization in an amount of from an upper limit of 500 ppm, 400 ppm, or 300 ppm to a lower limit of 50 ppm, 100 ppm, or 150 ppm.

Preferred ethylene copolymers useful herein are preferably a copolymer comprising at least 50 wt % ethylene and having up to 50 wt %, preferably 1 wt % to 35 wt %, even more preferably 1 wt % to 6 wt % of a C3 to C20 comonomer, preferably a C4 to C8 comonomer, preferably hexene or octene, based upon the weight of the copolymer. The polyethylene copolymers preferably have a composition distribution breadth index (CDBI) of 60% or more, preferably 60% to 80%, preferably 65% to 80%. In another preferred embodiment, the ethylene copolymers have a CDBI of 60% to 80%, preferably between 65% and 80%. Preferably these polymers are metallocene polyethylenes (mPEs).

Useful mPE homopolymers or copolymers may be produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings may be substituted or unsubstituted. Several commercial products produced with such catalyst/activator combinations are commercially available from ExxonMobil Chemical Company in Baytown, Tex. under the tradename EXCEED™ Polyethylene or ENABLE™ Polyethylene.

In one embodiment, a first ethylene polymer used herein is a polyethylene having a density of at least about 0.930 g/cm3, as determined based on ASTM D1505, and a melt index (MI) between 0.1 and 4 dg/min, as determined based on ASTM D1238 (190° C., 2.16 kg), while a second ethylene polymer used herein is a polyethylene having a density lower than 0.930 g/cm3, as determined based on ASTM D1505, and a melt index (MI) between 0.5 and 5 dg/min, determined based on ASTM D1238 (190° C., 2.16 kg).

In one embodiment, the 1% secant flexural modulus of preferred ethylene polymers ranges from 5 MPa to 1000 MPa, preferably from 100 MPa to 800 MPa in another embodiment, and from 10 MPa to 300 MPa in yet another embodiment, wherein a desirable polymer may exhibit any combination of any upper flexural modulus limit with any lower flexural modulus limit.

The crystallinity of the polymer may also be expressed in terms of crystallinity percent. The thermal energy for the highest order of polyethylene is estimated at 290 J/g. That is, 100% crystallinity is equal to 290 J/g. Preferably, the polymer has a crystallinity (as determined by DSC) within the range having an upper limit of 80%, 60%, 40%, 30%, or 20%, and a lower limit of 1%, 3%, 5%, 8%, or 10%. Alternately, the polymer has a crystallinity of 5% to 80%, preferably 10% to 70, more preferably 20% to 60%. Alternatively the polyethylene may have a crystallinity of at least 30%, preferably at least 40%, alternatively at least 50%, where crystallinity is determined

The level of crystallinity may be reflected in the melting point. In one embodiment of the present invention, the ethylene polymer has a single melting point. Typically, a sample of ethylene copolymer will show secondary melting peaks adjacent to the principal peak, which is considered together as a single melting point. The highest of these peaks is considered the melting point. The polymer preferably has a melting point (as determined by DSC) ranging from an upper limit of 150° C., 130° C. or 120° C. to a lower limit of 35° C., 40° C., or 45° C.

In a preferred embodiment, the weight ratio between the first polyethylene and the second polyethylene is about 1:2 to about 1:5, for example, about 1:2, about 1:2.5, about 1:3, about 1:3.5, about 1:4, about 1:4.5, or about 1:5.

It has been surprisingly discovered that use of a first polyethylene with a density of at least about 0.930 g/cm3 to prepare a film can particularly aid in achieving dual seal strengths with one single film over two sealing temperature ranges. Furthermore, when the first polyethylene is combined with a second polyethylene having a density lower than 0.930 g/cm3 and a propylene-based elastomer to prepare the inventive film, seal strength remains at a relatively low level at commonly used sealing temperatures and can be increased by simply elevating the sealing temperature to a relatively high range. Thus, the inventive film can improve the sealing performance of a package where nonpeelable seals are desired without necessarily resorting to a different film than the one used for the peelable seals.

### Additives

The film of the present invention may also contain various additives as is generally known in the art. Examples of such additives include an antioxidant, an ultraviolet light stabilizer, a thermal stabilizer, a slip agent, an antiblock, a pigment, a processing aid, a crosslinking catalyst, a flame retardant, a filler and a foaming agent, etc. In a preferred embodiment, the additives may each individually present at 0.01 wt % to 50 wt %, or from 0.01 wt % to 10 wt %, or from 0.1 wt % to 6 wt %, based upon the weight of the film.

### Mixing and Processing

The compositions described herein may be formed using conventional equipment and methods, such as by dry blending the individual components and subsequently melt mixing in a mixer, or by mixing the components together directly in a mixer, such as, for example, a Banbury™ mixer, a Haake™ mixer, a Brabender™ internal mixer, or a single or twin-screw extruder, which may include a compounding extruder and a side-arm extruder used directly downstream of a polymerization process. Additionally, additives may be included in the composition, in one or more components of the composition, and/or in a product formed from the composition, such as a film, as desired.

The polymers suitable for use in the present invention can be in any physical form when used for mixing. In one embodiment, reactor granules, defined as the granules of polymer that are isolated from the polymerization reactor prior to any processing procedures, are used to mix. The reactor granules typically have an average diameter of from 50 μm to 10 mm in one embodiment, and from 10 μm to 5 mm in another embodiment. In another embodiment, the polymer is in the form of pellets, such as, for example, having an average diameter of from 1 mm to 10 mm that are formed from melt extrusion of the reactor granules.

The components of the present invention can be mixed by any suitable means, and are typically mixed to yield an intimately mixed composition which may be a homogeneous, single phase mixture. For example, they may be mixed in a static mixer, batch mixer, extruder, or a combination thereof, that is sufficient to achieve an adequate dispersion of the components.

The mixing step may involve first dry blending using, for example, a tumble blender, where the polymers are brought into contact first, without intimate mixing, which may then be followed by melt mixing in an extruder. Another method of mixing the components is to melt mix the polymer pellets in an extruder or batch mixer. It may also involve a “master batch” approach, where the final concentrations are achieved by combining neat polymers at predetermined ratios. The mixing step may take place as part of a processing method used to fabricate articles, such as in the extruder on an injection molding machine or blown-film line or fiber line.

In a preferred aspect of the invention, the propylene-based elastomer and ethylene polymers are “melt mixed” in an apparatus such as an extruder (single or twin screw) or batch mixer. The ethylene polymers may also be “dry blended” with the propylene-based elastomer using a tumbler, double-cone blender, ribbon blender, or other suitable blender. In yet another embodiment, the ethylene polymer and the propylene-based elastomer are mixed by a combination of approaches, for example a tumbler followed by an extruder. A preferred method of mixing is to include the final stage of mixing as part of an article fabrication step, such as in the extruder used to melt and convey the composition for an injection molding machine or blown-film line.

In another aspect of the invention, the polymers may also be mixed in solution by any suitable means, by using a solvent that dissolves all polymer components to a significant extent. The mixing may occur at any temperature or pressure where the propylene-based elastomer and the ethylene polymers remain in solution. Preferred conditions include mixing at high temperatures, such as 10° C. or more, preferably 20° C. or more over the highest melting point among all the polymers. Such solution mixing would be particularly useful in processes where the polymers are made by solution process and additives are added directly to the finishing train, rather than added to the dry polymers in another mixing step altogether.

Those skilled in the art will be able to determine the appropriate procedure for mixing of the polymers to balance the need for intimate mixing of the component ingredients with the desire for process economy.

### Films, Seals and Packages

The compositions described above may be formed into films comprising a layer, i.e. monolayer or multilayer films. These films may be formed by any of the conventional techniques known in the art including blown extrusion, cast extrusion, co-extrusion, blow molding, casting, and extrusion blow molding.

In multilayer constructions, the other layer(s) may be any layer typically included in multilayer film structures. For example, the other layer or layers may be:

1. Polyolefins. Preferred polyolefins include homopolymers or copolymers of C₂ to C₄₀ olefins, preferably C₂ to C₂₀ olefins, preferably a copolymer of an α-olefin and another olefin or α-olefin (ethylene is defined to be an α-olefin for purposes of this invention). Preferably homopolyethylene, homopolypropylene, propylene copolymerized with ethylene and or butene, ethylene copolymerized with one or more of propylene, butene or hexene, and optional dienes. Preferred examples include thermoplastic polymers such as ultra-low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and compositions of thermoplastic polymers and elastomers, such as, for example, thermoplastic elastomers and rubber toughened plastics.

2. Polar polymers. Preferred polar polymers include homopolymers and copolymers of esters, amides, acetates, anhydrides, copolymers of a C₂ to C₂₀ olefin, such as ethylene and/or propylene and/or butene with one or more polar monomers such as acetates, anhydrides, esters, alcohol, and or acrylics. Preferred examples include polyesters, polyamides, ethylene vinyl acetate copolymers, and polyvinyl chloride.

3. Cationic polymers. Preferred cationic polymers include polymers or copolymers of geminally disubstituted olefins, α-heteroatom olefins and/or styrenic monomers. Preferred geminally disubstituted olefins include isobutylene, isopentene, isoheptene, isohexane, isooctene, isodecene, and isododecene. Preferred α-heteroatom olefins include vinyl ether and vinyl carbazole, preferred styrenic monomers include styrene, alkyl styrene, para-alkyl styrene, α-methyl styrene, chloro-styrene, and bromo-para-methyl styrene. Preferred examples of cationic polymers include butyl rubber, isobutylene copolymerized with para methyl styrene, polystyrene, and poly-α-methyl styrene.

4. Miscellaneous. Other preferred layers can be paper, wood, cardboard, metal, metal foils (such as aluminum foil and tin foil), metallized surfaces, glass (including silicon oxide (SiOₓ) coatings applied by evaporating silicon oxide onto a film surface), fabric, spunbond fibers, and non-wovens (particularly polypropylene spunbond fibers or non-wovens), and substrates coated with inks, dyes, pigments, and the like.

In particular, a multilayer film can also include layers comprising materials such as ethylene vinyl alcohol (EVOH), polyamide (PA), or polyvinylidene chloride (PVDC), so as to obtain barrier performance for the film where appropriate.

The films may vary in thickness depending on the intended application; however, films of a thickness from 1 μm to 250 μm are usually suitable. Films intended for packaging are usually from 10 to 60 micron thick. The peelable sealing layer can be made in any desired thickness, for example from 1 micron to 250 micron. Depending on the film used to prepare the seal, the sealing layer can be used as a monolayer, but more typically will be one layer of a multilayer structure, for example a 10 micron sealing layer with a 30 micron supporting layer.

In one aspect of the invention thin films may be made having a thickness of from 10 to 40 μm. Such thin films may be produced in a stiff oriented form (often referred to as “pre-stretched” by persons skilled in the art) and may be useful for laminating to inelastic materials such as biaxially oriented polypropylene (BOPP), biaxially oriented polyamide (nylon), polyethylene terephthalate (PET), foil or paper substrates. These laminates can optionally include additional barrier layers such as aluminium barrier.

A method for making a film may comprise the steps of: (a) preparing a layer comprising a propylene-based elastomer, a first polyethylene having a density of at least about 0.930 g/cm3, and a second polyethylene having a density lower than 0.930 g/cm3; and (b) forming a film comprising the layer in step (a). In one embodiment, the film is a monolayer film. In another embodiment, the film is a two-layer film having a sealing layer and an outer layer of polyethylene or a three-layer film having at least one sealing layer on either side of a core polyethylene layer.

In another embodiment of the invention, the films containing the compositions described herein, monolayer or multilayer, may be formed by using blown techniques, i.e., to form a blown film. For example, the composition can be extruded in a molten state through an annular die and then blown and cooled to form a tubular, blown film, which can then be axially slit and unfolded to form a flat film. As a specific example, blown films can be prepared as follows. The polymer composition is introduced into the feed hopper of an extruder, such as a 63.5 mm Egan extruder that is water-cooled, resistance heated, and has an L/D ratio of 24:1. The film can be produced using a 15.24 cm Sano die with a 2.24 mm die gap, along with a Sano dual orifice non-rotating, non-adjustable air ring. The film is extruded through the die into a film cooled by blowing air onto the surface of the film. The film is drawn from the die typically forming a cylindrical film that is cooled, collapsed and, optionally, subjected to a desired auxiliary process, such as slitting, treating, sealing, or printing. Typical melt temperatures are from about 175° C. to about 225° C. Blown film rates are generally from about 5 to about 30 lbs per hour per inch (about 4.35 to about 26.11 kilograms per hour per centimeter) of die circumference. The finished film can be wound into rolls for later processing. A particular blown film process and apparatus suitable for forming films according to embodiments of the present invention is described in U.S. Pat. No. 5,569,693. Of course, other blown film forming methods can also be used.

The compositions prepared as described herein are also suited for the manufacture of blown film in a high-stalk extrusion process. In this process, a polyethylene melt is fed through a gap (typically 0.5 to 1.6 mm) in an annular die attached to an extruder and forms a tube of molten polymer which is moved vertically upward. The initial diameter of the molten tube is approximately the same as that of the annular die. Pressurized air is fed to the interior of the tube to maintain a constant air volume inside the bubble. This air pressure results in a rapid 3-to-9-fold increase of the tube diameter which occurs at a height of approximately 5 to 10 times the die diameter above the exit point of the tube from the die. The increase in the tube diameter is accompanied by a reduction of its wall thickness to a final value ranging from approximately 12.7 to 50 microns and by a development of biaxial orientation in the melt. The expanded molten tube is rapidly cooled (which induces crystallization of the polymer), collapsed between a pair of nip rolls and wound onto a film roll.

In a preferred embodiment, films prepared as described herein have at least one of the following properties: (i) a seal strength of about 1 N/15 mm to about 3 N/15 mm at a sealing temperature of 75° C. to 100° C., (ii) a seal strength of about 0.8 N/15 mm to about 4 N/15 mm at a sealing temperature of 100° C. to 110° C., (iii) a seal strength of about 8 N/15 mm to about 15 N/15 mm at a sealing temperature of 105° C. to 150° C., and (iv) a seal strength of about 15 N/15 mm to about 22 N/15 mm at a sealing temperature of 120° C. to 160° C. More preferably, the inventive films show improved sealing performance with dual plateaus of seal strengths. In one preferred embodiment, the film has a seal strength of about 1 N/15 mm to about 3 N/15 mm at a sealing temperature of 75° C. to 100° C. and a seal strength of about 8 N/15 mm to about 15 N/15 mm at a sealing temperature of 105° C. to 150° C. In another preferred embodiment, the film has a seal strength of about 0.8 N/15 mm to about 4 N/15 mm at a sealing temperature of 100° C. to 110° C. and a seal strength of about 15 N/15 mm to about 22 N/15 mm at a sealing temperature of 120° C. to 160° C.

The seals of the present invention, both peelable and nonpeelable seals, can be made by any process such as extrusion coating, lamination, sheet extrusion, injection molding or cast film processes.

In a particularly desirable embodiment, as a result of the dual seal strengths the films of the present invention respectively have over two sealing temperature ranges, packages made from the films can obtain a seal strength of about 0.8 N/15 mm to about 4 N/15 mm at the intended peelable seals and a seal strength of about 8 N/15 mm to about 22 N/15 mm at the intended nonpeelable seals.

The peelable seals of the present invention will have a heat seal initiation temperature of lower than 120° C., preferably lower than 110° C., more preferably lower than 100° C.

Also provided are methods for making a package, comprising the steps of: (a) preparing a layer comprising a propylene-based elastomer, a first polyethylene having a density of at least about 0.930 g/cm3, and a second polyethylene having a density lower than 0.930 g/cm3; (b) forming a film comprising the layer in step (a); and (c) forming a package comprising the film in step (b). Preferably, step (c) comprises: preparing a peelable seal comprising the film in step (b); preparing a nonpeelable seal comprising the film in step (b); and combining the peelable seal with the nonpeelable seal to form a package. Preferably, the peelable seal is prepared at a sealing temperature of 75° C. to 110° C. Preferably, the nonpeelable seal is prepared at a sealing temperature of 105° C. to 160° C. This feasibility of preparing a package with a film to provide both peelable and nonpeelable seals by controlling sealing temperatures may greatly promote ease and cost-effectiveness in the package manufacturing process. It should be understood by one of ordinary skill in the art that the seal strength may typically be somewhat less for flexible packaging and somewhat higher for rigid packaging.

Other embodiments of the present invention can include:

1. A film, comprising a layer comprising:

a propylene-based elastomer;

a first polyethylene having a density of at least about 0.930 g/cm³; and

a second polyethylene having a density lower than 0.930 g/cm³.

2. The film of paragraph 1, wherein the film has at least one of the following properties: (i) a seal strength of about 1 N/15 mm to about 3 N/15 mm (EMC method) at a sealing temperature of 75° C. to 100° C., (ii) a seal strength of about 0.8 N/15 mm to about 4 N/15 mm at a sealing temperature of 100° C. to 110° C., (iii) a seal strength of about 8 N/15 mm to about 15 N/15 mm at a sealing temperature of 105° C. to 150° C., and (iv) a seal strength of about 15 N/15 mm to about 22 N/15 mm at a sealing temperature of 120° C. to 160° C.
3. The film of paragraph 1 or 2, wherein the film has a seal strength of about 1 N/15 mm to about 3 N/15 mm at a sealing temperature of 75° C. to 100° C. and a seal strength of about 8 N/15 mm to about 15 N/15 mm at a sealing temperature of 105° C. to 150° C.
4. The film of any of paragraphs 1 to 3, wherein the film has a seal strength of about 0.8 N/15 mm to about 4 N/15 mm at a sealing temperature of 100° C. to 110° C. and a seal strength of about 15 N/15 mm to about 22 N/15 mm at a sealing temperature of 120° C. to 160° C.
5. The film of any of paragraphs 1 to 4, wherein the propylene-based elastomer has at least about 60 wt % propylene-derived units and about 3 to about 25 wt % ethylene-derived units, based on total weight of the propylene-based elastomer, and a heat of fusion of less than about 80 J/g.
6. The film of any of paragraphs 1 to 5, wherein the propylene-based elastomer is present in an amount of about 5 to about 50 wt %, based on total weight of the polymer in the layer.
7. The film of any of paragraphs 1 to 6, wherein the weight ratio between the first polyethylene and the second polyethylene is about 1:2 to about 1:5.
8. The film of any of paragraphs 1 to 7, further comprising in the layer at least one of an antioxidant, an ultraviolet light stabilizer, a thermal stabilizer, a slip agent, an antiblock, a pigment, a processing aid, a crosslinking catalyst, a flame retardant, a filler and a foaming agent.
9. A film, comprising a layer comprising:

a propylene-based elastomer in an amount of about 10 wt % to about 30 wt %, based on total weight of the polymer in the layer, wherein the propylene-based elastomer has at least about 60 wt % propylene-derived units and about 3 to about 25 wt % ethylene-derived units, based on total weight of the propylene-based elastomer, and a heat of fusion of less than about 80 J/g;

a first polyethylene having a density of about 0.930 to about 0.965 g/cm³ in an amount of about 10 wt % to about 30 wt %, based on total weight of the polymer in the layer; and

a second polyethylene having a density of about 0.915 to about 0.929 g/cm³ in an amount of about 50 wt % to about 75 wt %, based on total weight of the polymer in the layer.

10. The film of paragraph 9, further comprising a second layer comprising a third polyethylene having a density of about 0.940 to about 0.965 g/cm³ in an amount of about 50 wt % to about 100 wt %, based on total weight of the polymer in the second layer.
11. A peelable seal comprising the film of any of paragraphs 1 to 10.
12. A nonpeelable seal comprising the film of any of paragraphs 1 to 10.
13. A package comprising the peelable seal of paragraph 11 and the nonpeelable seal of paragraph 12.
14. The package of paragraph 13, wherein the package has a seal strength of about 0.8 N/15 mm to about 4 N/15 mm at the peelable seal.
15. The package of paragraph 13 or 14, wherein the package has a seal strength of about 8 N/15 mm to about 22 N/15 mm at the nonpeelable seal.
16. A method for making a film, comprising the steps of:
(a) preparing a layer comprising a propylene-based elastomer, a first polyethylene having a density of at least about 0.930 g/cm³, and a second polyethylene having a density lower than 0.930 g/cm³; and
(b) forming a film comprising the layer in step (a).
17. The method of paragraph 16, wherein the film has at least one of the following properties: (i) a seal strength of about 1 N/15 mm to about 3 N/15 mm at a sealing temperature of 75° C. to 100° C., (ii) a seal strength of about 0.8 N/15 mm to about 4 N/15 mm at a sealing temperature of 100° C. to 110° C., (iii) a seal strength of about 8 N/15 mm to about 15 N/15 mm at a sealing temperature of 105° C. to 150° C., and (iv) a seal strength of about 15 N/15 mm to about 22 N/15 mm at a sealing temperature of 120° C. to 160° C.
18. A method for making a package, comprising the steps of:
(a) preparing a layer comprising a propylene-based elastomer, a first polyethylene having a density of at least about 0.930 g/cm³, and a second polyethylene having a density lower than 0.930 g/cm³;
(b) forming a film comprising the layer in step (a); and
(c) forming a package comprising the film in step (b).
19. The method of paragraph 18, wherein the film in step (b) is formed by blown extrusion, cast extrusion, co-extrusion, blow molding, casting, or extrusion blow molding.
20. The method of paragraph 18 or 19, wherein step (c) comprises:

preparing a peelable seal comprising the film in step (b);

preparing a nonpeelable seal comprising the film in step (b); and

combining the peelable seal with the nonpeelable seal to form a package.

21. The method of paragraph 20, wherein the peelable seal is prepared at a sealing temperature of 75° C. to 110° C.
22. The method of paragraph 20 or 21, wherein the nonpeelable seal is prepared at a sealing temperature of 105° C. to 160° C.
23. The method of any of paragraphs 20 to 22, wherein the package has a seal strength of about 0.8 N/15 mm to about 4 N/15 mm at the peelable seal.
24. The method of any of paragraphs 20 to 23, wherein the package has a seal strength of about 8 N/15 mm to about 22 N/15 mm at the nonpeelable seal.

### EXAMPLES

The present invention, while not meant to be limited by, may be better understood by reference to the following examples and tables.

### Example 1

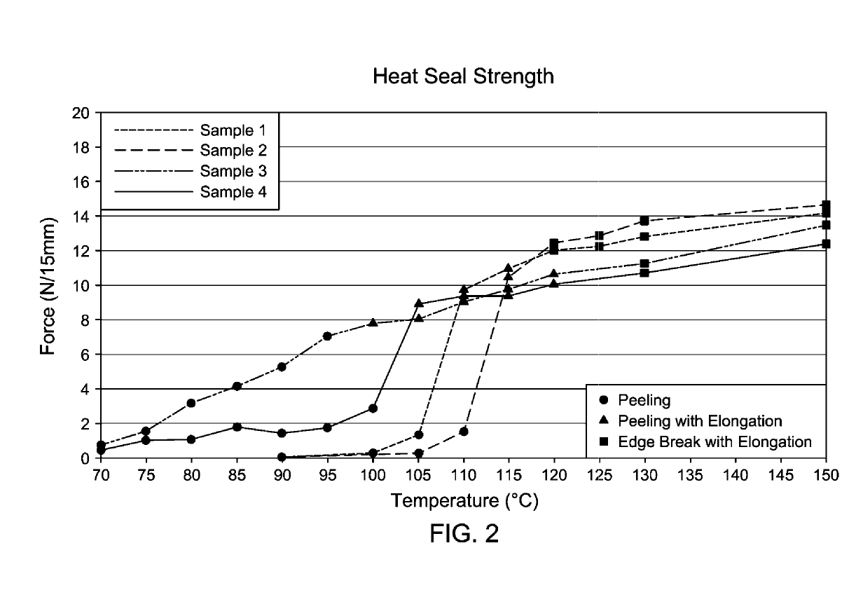

Example 1 illustrates sealing performance demonstrated by a monolayer sample of the inventive film (Sample 4) in comparison with other comparative monolayer samples (Samples 1-3) when they were processed into seals at a sealing temperature ranging from 70° C. to 150° C. A 50 micron monolayer structure was prepared for each sample. VISTAMAXX™ 3020FL propylene-based elastomer (ExxonMobil Chemical Company, Houston, Tex., USA) was used in Samples 3 and 4. ENABLE™ 35-05CH mPE resin (ExxonMobil Chemical Company, Houston, Tex., USA) (density: 0.935 g/cm³) was used in Samples 2 and 4. ENABLE™ 20-05CH mPE resin (ExxonMobil Chemical Company, Houston, Tex., USA) (density: 0.920 g/cm³) was used in Samples 1 and 3. EXCEED™ 2018EB mPE resin (ExxonMobil Chemical Company, Houston, Tex., USA) (density: 0.918 g/cm³) was used in all four samples. Formulations with components and corresponding amounts used for the samples are listed below in Table 1. The seal strength was measured by EMC method as described herein. The results are depicted in FIG. 2.

TABLE 1
Formulations (wt %) for the monolayer film samples of Example 1

| Sample No. | 1 | 2 | 3 | 4 |
|---|---|---|---|---|
| Vistamaxx ™ 3020FL | — | — | 15 | 15 |
| Enable ™ 35-05CH | — | 25 | — | 21 |
| Enable ™ 20-05CH | 25 | — | 21 | — |
| Exceed ™ 2018EB | 75 | 75 | 64 | 64 |

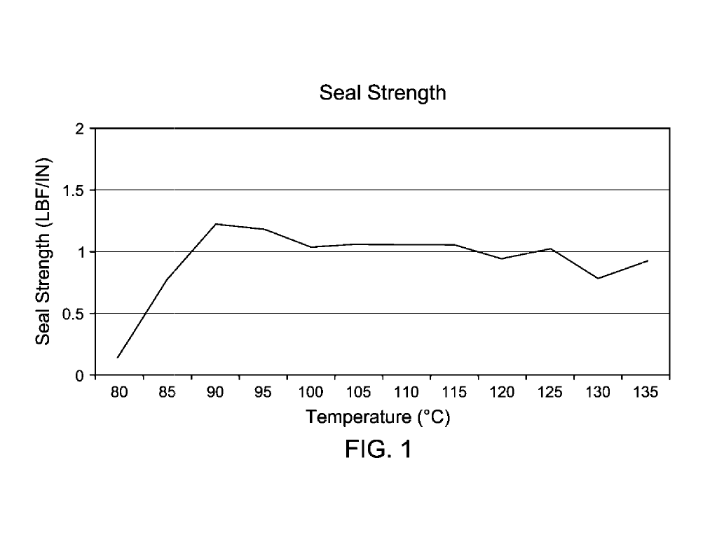

As shown in FIG. 2, by reaching a seal strength as high as about 8 N/15 mm to about 15 N/15 mm a sealing temperature of 105° C. to 150° C., Sample 4 of the inventive film overcame the long-standing problem of low seal strength regardless of the sealing temperature during package manufacturing with films prepared from conventional EVA and polyethylene polymers (e.g., see FIG. 1). Particularly, without being bound by theory, it is believed that the presence of a polyethylene having a relatively high density of at least about 0.930 g/cm³ contributes to dual plateaus of seal strengths over the defined sealing temperature range. Sample 4 demonstrated a seal strength well suited for use as a peelable seal when processed at a relatively low sealing temperature between 75° C. and 100° C. and demonstrated a seal strength desirable for use as a nonpeelable seal when processed at a relatively high sealing temperature between 105° C. and 150° C. Therefore, a package with both peelable and nonpeelable seals can be made by the inventive film by controlling the sealing temperature during processing without compromising package integrity or necessarily relying on combination of different films.

### Example 2

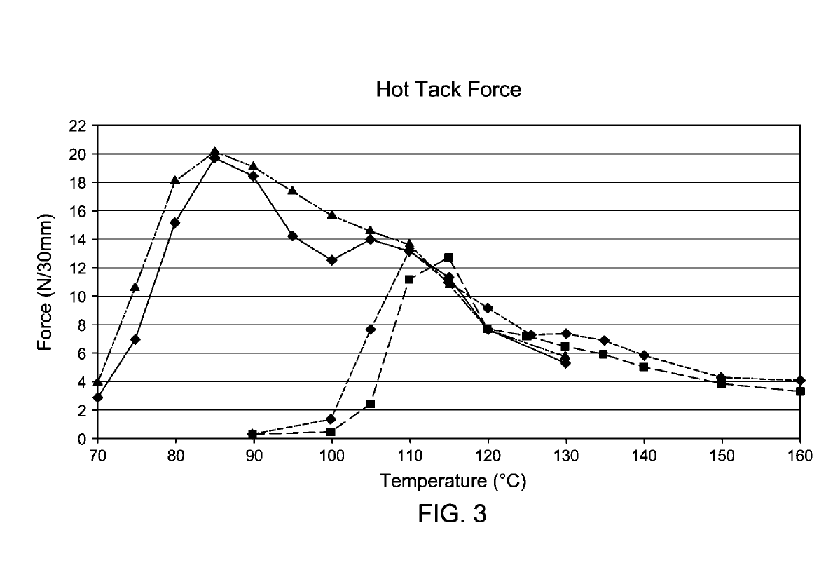

Hot tack forces of the samples in Example 1 were determined based on ASTM F1921-12 using a J&B Hot Tack Tester Model 4000 with a 0.5 sec dwell time, with a 0.5 MPa bar pressure pulled at a speed of 200 mm/sec after 0.4 sec of welding seal. The results are presented in FIG. 3.

Higher hot tack force and broader hot tack window was observed with Sample 4 of the inventive film in contrast to the comparative samples without addition of the propylene-based elastomer in the film. High hot tack force is desirable to maintain seal integrity before the sealing layer is cooled to room temperature and to improve packaging efficiency.

### Example 3

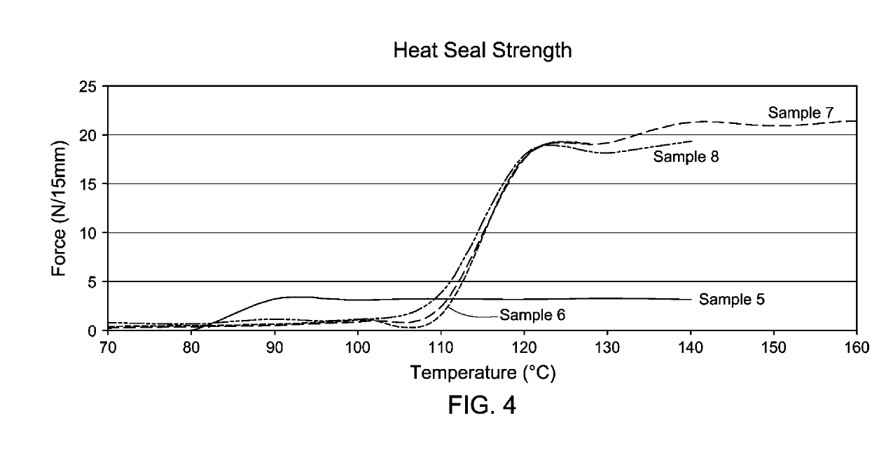

Example 3 illustrates sealing performance demonstrated by two-layer samples of the inventive film (Samples 6-8) in comparison with a comparative commercially available film sample (Sample 5) when they were processed into seals at a sealing temperature ranging from 70° C. to 160° C. A 50 micron two-layer structure including a sealing layer and an outer layer was prepared by a co-extrusion blown film line for each sample. Samples 6-8 included a sealing layer composed of 20 wt % of Vistamaxx™ 3020FL propylene-based elastomer, 20 wt % of Enable™ 35-05HH mPE resin (density: 0.935 g/cm³) and 60 wt % of Exceed™ 2018HA mPE resin (density: 0.918 g/cm³), based on the total weight of the sealing layer, and an outer layer made of ExxonMobil™ HDPE HTA 108 resin (density: 0.961 g/cm³). The sealing layer was present in a volume ratio of 10% in Samples 6 and 7 and in a volume ratio of 25% in Sample 8, based on the total thickness of each film sample. The comparative Sample 5 included a 5-micron ionomer-based sealing layer and a 45-micron HDPE outer layer. The seal strength was measured after 24 hours of welding seal for Samples 5, 6 and 8, and was measured after ten days of welding seal for Sample 7. The results are depicted in FIG. 4.

It can be seen from the curves in FIG. 4 that compared with Example 1, addition of an HDPE layer into the film of the same thickness steepened the dual plateaus profile of seal strength. The difference between Samples 6 and 8 indicated that the thicker the sealing layer was, the less steepened the plateaus became, thus moving the sealing temperature ranges for both peelable and nonpeelable seals upward, to a range of 100° C. to 110° C. and a range of 120° C. to 160° C., respectively. This further illustrates combination of the propylene-based elastomer, the first polyethylene and the second polyethylene as described herein in the sealing layer contributes to dual seal strengths of the inventive film.

All documents described herein are incorporated by reference herein, including any priority documents and/or testing procedures. When numerical lower limits and numerical upper limits are listed herein, ranges from any lower limit to any upper limit are contemplated. As is apparent from the foregoing general description and the specific embodiments, while forms of the invention have been illustrated and described, various modifications can be made without departing from the spirit and scope of the invention. Accordingly, it is not intended that the invention be limited thereby.

What is claimed is:

1. A film, comprising a layer comprising:
a propylene-based elastomer;
a first polyethylene having a density of at least about 0.930 g/cm³; and
a second polyethylene having a density lower than 0.930 g/cm³.

2. The film of claim 1, wherein the film has at least one of the following properties: (i) a seal strength of about 1 N/15 mm to about 3 N/15 mm (EMC method) at a sealing temperature of 75° C. to 100° C., (ii) a seal strength of about 0.8 N/15 mm to about 4 N/15 mm at a sealing temperature of 100° C. to 110° C., (iii) a seal strength of about 8 N/15 mm to about 15 N/15 mm at a sealing temperature of 105° C. to 150° C., and (iv) a seal strength of about 15 N/15 mm to about 22 N/15 mm at a sealing temperature of 120° C. to 160° C.

3. The film of claim 1, wherein the film has a seal strength of about 1 N/15 mm to about 3 N/15 mm at a sealing temperature of 75° C. to 100° C. and a seal strength of about 8 N/15 mm to about 15 N/15 mm at a sealing temperature of 105° C. to 150° C.

4. The film of claim 1, wherein the film has a seal strength of about 0.8 N/15 mm to about 4 N/15 mm at a sealing temperature of 100° C. to 110° C. and a seal strength of about 15 N/15 mm to about 22 N/15 mm at a sealing temperature of 120° C. to 160° C.

5. The film of claim 1, wherein the propylene-based elastomer has at least about 60 wt % propylene-derived units and about 3 to about 25 wt % ethylene-derived units, based on total weight of the propylene-based elastomer, and a heat of fusion of less than about 80 J/g.

6. The film of claim 1, wherein the propylene-based elastomer is present in an amount of about 5 to about 50 wt %, based on total weight of the polymer in the layer.

7. The film of claim 1, wherein the weight ratio between the first polyethylene and the second polyethylene is about 1:2 to about 1:5.

8. The film of claim 1, further comprising in the layer at least one of an antioxidant, an ultraviolet light stabilizer, a thermal stabilizer, a slip agent, an antiblock, a pigment, a processing aid, a crosslinking catalyst, a flame retardant, a filler and a foaming agent.

9. A film, comprising a layer comprising:
a propylene-based elastomer in an amount of about 10 wt % to about 30 wt %, based on total weight of the polymer in the layer, wherein the propylene-based elastomer has at least about 60 wt % propylene-derived units and about 3 to about 25 wt % ethylene-derived units, based on total weight of the propylene-based elastomer, and a heat of fusion of less than about 80 J/g;
a first polyethylene having a density of about 0.930 to about 0.965 g/cm³ in an amount of about 10 wt % to about 30 wt %, based on total weight of the polymer in the layer; and
a second polyethylene having a density of about 0.915 to about 0.929 g/cm³ in an amount of about 50 wt % to about 75 wt %, based on total weight of the polymer in the layer.

10. The film of claim 9, further comprising a second layer comprising a third polyethylene having a density of about 0.940 to about 0.965 g/cm³ in an amount of about 50 wt % to about 100 wt %, based on total weight of the polymers in the second layer.

11. A peelable seal comprising the film of claim 1.

12. A nonpeelable seal comprising the film of claim 1.

13. A package comprising the peelable seal of claim 11 and the nonpeelable seal of claim 12.

14. The package of claim 13, wherein the package has a seal strength of about 0.8 N/15 mm to about 4 N/15 mm at the peelable seal.

15. The package of claim 13, wherein the package has a seal strength of about 8 N/15 mm to about 22 N/15 mm at the nonpeelable seal.

16. A method for making a film, comprising the steps of:
(a) preparing a layer comprising a propylene-based elastomer, a first polyethylene having a density of at least about 0.930 g/cm³, and a second polyethylene having a density lower than 0.930 g/cm³; and
(b) forming a film comprising the layer in step (a).

17. The method of claim 16, wherein the film has at least one of the following properties: (i) a seal strength of about 1 N/15 mm to about 3 N/15 mm at a sealing temperature of 75° C. to 100° C., (ii) a seal strength of about 0.8 N/15 mm to about 4 N/15 mm at a sealing temperature of 100° C. to 110° C., (iii) a seal strength of about 8 N/15 mm to about 15 N/15 mm at a sealing temperature of 105° C. to 150° C., and (iv) a seal strength of about 15 N/15 mm to about 22 N/15 mm at a sealing temperature of 120° C. to 160° C.

18. A method for making a package, comprising the steps of:
(a) preparing a layer comprising a propylene-based elastomer, a first polyethylene having a density of at least about 0.930 g/cm³, and a second polyethylene having a density lower than 0.930 g/cm³;
(b) forming a film comprising the layer in step (a); and
(c) forming a package comprising the film in step (b).

19. The method of claim 18, wherein the film in step (b) is formed by blown extrusion, cast extrusion, co-extrusion, blow molding, casting, or extrusion blow molding.

20. The method of claim 18, wherein step (c) comprises:
preparing a peelable seal comprising the film in step (b);
preparing a nonpeelable seal comprising the film in step (b); and
combining the peelable seal with the nonpeelable seal to form a package.

21. The method of claim 20, wherein the peelable seal is prepared at a sealing temperature of 75° C. to 110° C.

22. The method of claim 20, wherein the nonpeelable seal is prepared at a sealing temperature of 105° C. to 160° C.

23. The method of claim 20, wherein the package has a seal strength of about 0.8 N/15 mm to about 4 N/15 mm at the peelable seal.

24. The method of claim 20, wherein the package has a seal strength of about 8 N/15 mm to about 22 N/15 mm at the nonpeelable seal.
